(19) United States
(12) Patent Application Publication
(10) Pub. No.: US 2026/0248668 A1
(43) Pub. Date: Aug. 27, 2026

(54) PATIENT MOBILITY APPARATUS AND CORRESPONDING METHOD

(71) Applicant: Medline Industries, LP, Northfield, IL (US)

(72) Inventors: Alyssa Kurt, Kenosha, WI (US); David Szum, Wauconda, IL (US)

(21) Appl. No.: 19/061,182

(22) Filed: Feb. 24, 2025

(51) Int. Cl. A61G 7/10

(52) U.S. Cl. CPC A61G 7/1026; A61G 7/1021; A61G 2200/16

(57) ABSTRACT

A patient mobility apparatus that can be used with or without a patient lift apparatus can comprise an inflatable envelope having a patient-facing surface, an opposing surface, and at least two pairs of opposing first handles attached proximal to exterior opposite edges of the inflatable envelope, wherein the first handles are attached to the opposing surface but not to the patient-facing surface. By one approach, one or more flexible reinforcement members can be attached to the opposing surface along and proximal to one or more exterior edges of the inflatable envelope but not to the patient-facing surface. By one approach, such flexible reinforcement members are not attached to the aforementioned first handles.

### TECHNICAL FIELD

These teachings relate generally to assisting with the movement of a living being.

### BACKGROUND

Living beings, such as human beings, sometimes need assistance in order to move in some particular manner. Such a circumstance can arise, for example, with persons who are patients in a hospital, nursing home, or rehabilitation center setting. When the person who needs such assistance is heavy, the persons who are providing the necessary assistance are themselves subject to risk of injury or strain.

Patient mobility apparatuses, such as so-called inflatable mattresses, are sometimes used to help in the foregoing regards. Such inflatable mattresses sometimes have a number of features designed to facilitating sliding the person and/or lifting (and even transporting) the person needing assistance.

Due to the existence of internal air flow management architecture, all of the current solutions for load bearing architecture require the load bearing architecture to be external to the inflatable mattress.

Unfortunately, existing solutions in these regards do not meet all user requirements in all application settings all of the time.

### BRIEF DESCRIPTION OF DRAWINGS

The above needs are at least partially met through provision of the patient mobility apparatus and corresponding method described in the following detailed description, particularly when studied in conjunction with the drawings, wherein:

FIG. 1 comprises an exploded perspective view as configured in accordance with various embodiments of these teachings;

FIG. 2 comprises a bottom plan view as configured in accordance with various embodiments of these teachings;

FIG. 3 comprises a detail perspective view as configured in accordance with various embodiments of these teachings;

FIG. 4 comprises a detail plan view as configured in accordance with various embodiments of these teachings;

FIG. 5 comprises a detail plan view as configured in accordance with various embodiments of these teachings;

FIG. 6 comprises a cross-sectional detail view taken across line A-A in FIG. 2 showing the apparatus in an inflated configuration in accordance with various embodiments of these teachings;

FIG. 7 comprises a detail plan view as configured in accordance with various embodiments of these teachings;

FIG. 8 comprises a detail plan view as configured in accordance with various embodiments of these teachings; and

FIG. 9 comprises plan views in accordance with various embodiments of these teachings.

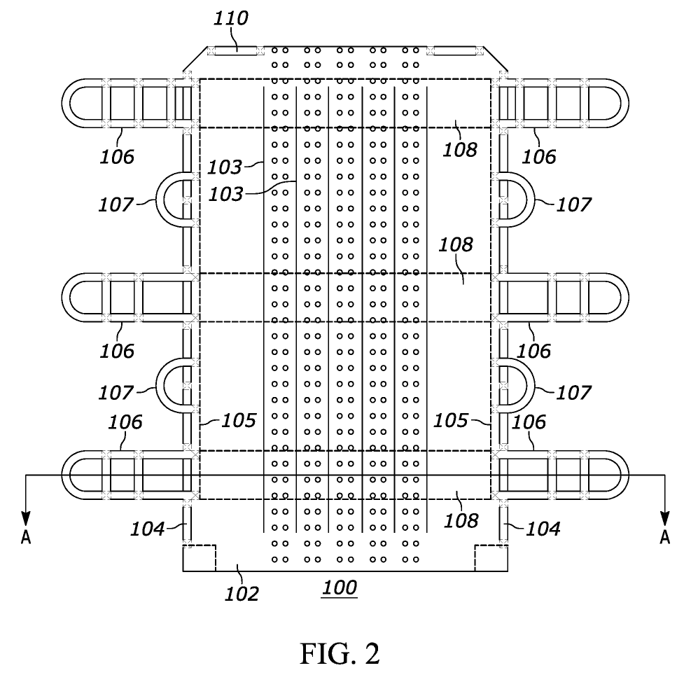

Elements in the figures are illustrated for simplicity and clarity and have not necessarily been drawn to scale (though FIG. 2, as one embodiment, can be viewed as being drawn to scale). For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word "or" when used herein shall be interpreted as having a disjunctive construction rather than a conjunctive construction unless otherwise specifically indicated. As used herein, the word "proximal" will be understood to mean within a range of 0 to 2 inches."

### DETAILED DESCRIPTION

Generally speaking, pursuant to these various embodiments, a patient mobility apparatus that can be used with or without a patient lift apparatus can comprise an inflatable envelope having a patient-facing surface, an opposing surface, and at least two pairs of opposing first handles attached proximal to exterior opposite edges of the inflatable envelope, wherein the first handles are attached, in this illustrative example, to the opposing surface but not to the patient-facing surface. (If desired, these teachings will accommodate attaching these first handles to only the patient-facing surface and not the opposing surface, or to both the opposing surface and the patient-facing surface. As yet another approach, these teaching will accommodate attaching one or more of the first handles to only the opposing surface while attaching one or more of the first handles to only the patient-facing surface and/or to both the opposing surface and the patient-facing surface.) By one approach, one or more flexible reinforcement members can be attached to the opposing surface along and proximal to one or more exterior edges of the inflatable envelope but not to the patient-facing surface. By one approach, such flexible reinforcement members are not attached to the aforementioned first handles.

One approach, the aforementioned first handles are each configured as patient lift apparatus connections. If desired, however, one or more of these first handles can be configured as both patient lift apparatus connections and human hand connections.

By one approach, the patient mobility apparatus can further include one or more lateral support beams (such as, for example, a mesh fabric) that each attach between one pair of the aforementioned opposing first handles to thereby provide lateral support in those regards. Such lateral support beams can be disposed interior to the inflatable envelope.

By one approach, the patient mobility apparatus can include at least two pairs of opposing second handles that are attached on exterior opposite edges of the inflatable envelope, wherein the opposing second handles are attached to the opposing surface but not to the patient-facing surface and wherein the second handles are each configured only as human hand connections. (The aforementioned attachment on the exterior opposite edges of the inflatable envelope may occur, in whole or in part, in an area where inflation occurs or where inflation does not occur. For many application settings it may be useful to make the attachment proximal to the exterior opposite edges.) When the apparatus includes the aforementioned lateral support beam, by one approach none of those lateral support beams are attached to any of the aforementioned second handles.

So configured, these teachings can provide a patient mobility apparatus that is highly durable and strong, comprised of reasonably inexpensive materials and requiring no overly expensive manufacturing processes, intuitive for use while also accommodating multiple user modalities, and comfortable for the person being moved. These teachings can also provide an internal load bearing support architecture that does not interfere with any air flow management related processes.

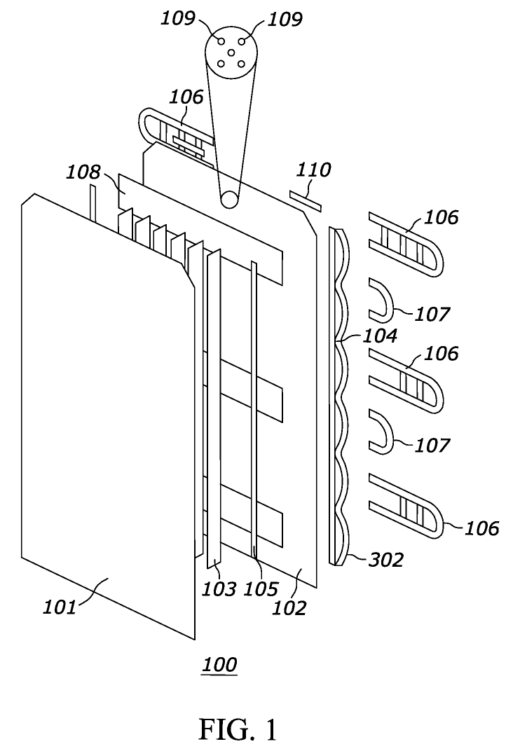

These and other benefits may become clearer upon making a thorough review and study of the following detailed description. Referring now to the drawings, and in particular to FIGS. 1 and 2, an illustrative patient mobility apparatus 100 that is compatible with many of these teachings will be presented. For the sake of an illustrative example, the patient mobility apparatus 100 is presented in the form factor of an inflatable mattress.

The depicted patient mobility apparatus 100 includes an inflatable envelope having a patient-facing surface 101 and an opposing surface 102. In a typical application setting, when a supported body lies upon the inflatable envelope, the opposing surface 102 might face towards and rest upon a mattress, stretcher, patient support wedge, or the like. The patient- facing surface 101 would face towards the supported body, and the supported body would lie directly upon that patient-facing surface 101 (notwithstanding that sheets, blankets, or other bedding or the like, one or more incontinence pads/chux, and/or one or more patient support wedges or pillows might also be disposed between the body and the patient-facing surface 101).

The patient-facing surface 101 and the opposing surface 102 can be composed of a relatively light, waterproof, and airtight flexible material such as nylon. These structures are sized here to more or less conform to the dimensions that characterize the needs of a given application setting, such as the dimensions of a bed mattress. The edges of these two structures are sealed to form an inflatable envelope. This sealing may be achieved via any suitable and desired approach, including but not limited to stitching, adhesives, and/or heat welding.

The opposing surface 102 can have a plurality of small apertures 109 formed there through. So configured, when inflated with air, some of the air can escape through these apertures. That air flow, in turn, can help reduce friction when sliding the patient mobility apparatus laterally, longitudinally, or otherwise over a supporting surface such as a mattress. (Alternatively, if desired, the opposing surface 102 may have no such apertures.) To support such use, the inflatable envelope can have a suitable interface (not shown) to receive incoming air. Such interfaces and their use with inflatable mattresses are known in the art and require no further elaboration here.

If desired, and as illustrated in FIGS. 1 and 2, one or more baffles 103 can be longitudinally disposed and affixed within the inflatable envelope. In this illustrative example, a plurality of baffles 103, formed here of flexible nylon material, are attached along both longitudinal edges to the patient-facing surface 101 and the opposing surface 102, respectively. Such baffles 103 can help to direct air flow evenly within the inflatable envelope and can also help ensure that the inflatable envelope maintains a desired shape during use. These teachings will also accommodate, if desired, disposing and affixing one or more baffles in a lateral configuration as well as a configuration that employs both longitudinally and laterally disposed baffles. If desired, one or more baffles could also be disposed and affixed at other angles as well. In an alternate embodiment, a device can be made without baffles. The inflatable envelope shape can be maintained by attaching the patient-facing surface 101 and opposing surface 102 directly to each other at various points throughout the inflatable envelope.

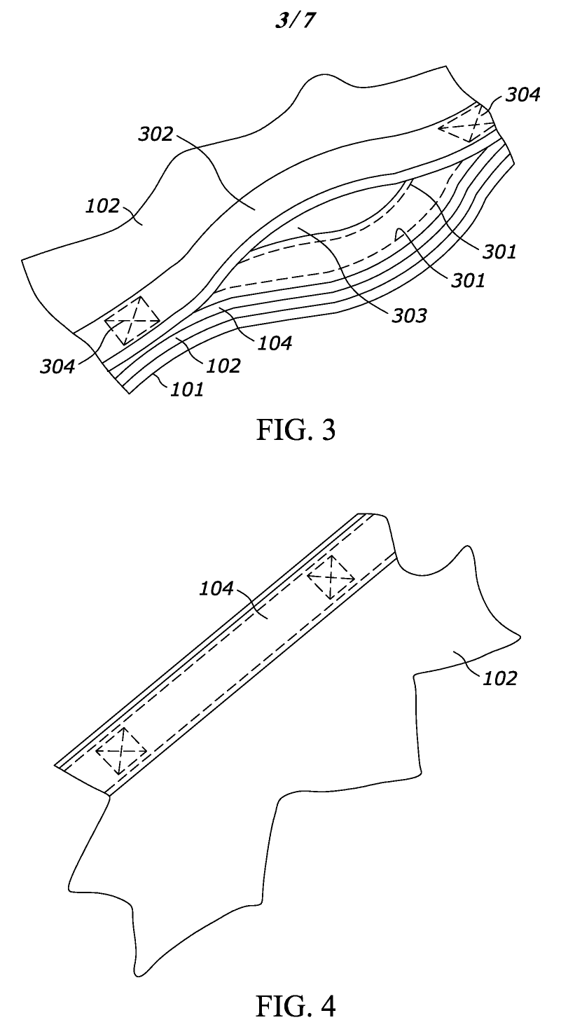

If desired, by one optional approach and as shown in these figures, a flexible reinforcement member 104 can be attached at and proximal to the longitudinal edges of the inflatable envelope. These flexible reinforcement members 104 can be disposed along the outer edges of the opposing surface 102 and can be attached (for example, via stitching) to the opposing surface 102 and to the patient-facing surface 101. FIGS. 3 and 4 offer a more detailed view in these regards, where this flexible reinforcement member 104 is disposed over the opposing surface 102 and is secured to the opposing surface 102 and the patient-facing surface 101 by stitching 301 (as illustrated, and/or by other methods such as the application of heat or ultrasonic energy). FIG. 4 presents this arrangement from the underside of the opposing surface 102.

FIG. 3 also illustrates that, if desired, an additional flexible reinforcement member 302 can optionally be overlaid atop one or more of the above-described components (including, when present, the flexible reinforcement member 104). By only securing this additional flexible reinforcement member 302 at spaced apart intervals 304, openings 303 that comprise human hand connections can be provided at one or more locations along the longitudinal edges of the inflatable envelope. These human hand connections, disposed in close proximity to the edges of the inflatable envelope, can be particularly suitable for use in particular application settings and hence can offer a useful patient movement modality option.

If desired, one or more optional additional flexible reinforcement members 110 can be disposed along the outer, transverse edge of the opposing surface 102 and can be attached (for example, via stitching) to the opposing surface 102 and to the patient- facing surface 101 as shown in FIGS. 1 and 2. By securing the additional flexible reinforcement member 110 at a sufficiently-sized spaced apart interval, an opening for a human hand connection can be provided.

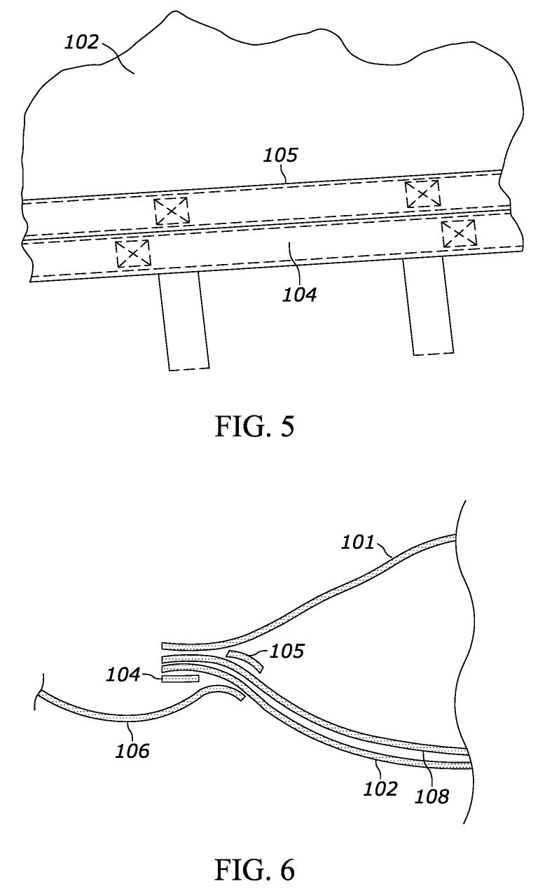

If desired, and in addition to the aforementioned flexible reinforcement member 104, a second flexible reinforcement member 105 can be disposed parallel and adjacent to the aforementioned flexible reinforcement member 104. Referring momentarily to FIGS. 5 and 6 (where FIG. 5 is a top plan view with the patient-facing surface 101 not shown for the purpose of clarity), this second flexible reinforcement member 105 can be disposed on the inner surface of the opposing surface 102 of the inflatable envelope (as compared to the aforementioned flexible reinforcement member 104 which is attached on the outer surface of the opposing surface 102 of the inflatable envelope). Again, this second flexible reinforcement member 105 can be secured using any appropriate attachment mechanism with stitching being shown in these figures. If desired, all of these flexible reinforcement members can be comprised of a similar material such as one-inch-wide polypropylene webbing. To be clear, this second flexible reinforcement member 105 is directly attached only to the opposing surface 102 of the inflatable envelope and not also to the patient-facing surface 101. (By one approach, if desired, one or more of the flexible reinforcement members 105 could be attached, instead, to the patient-facing surface 101 but not the opposing surface 102.)

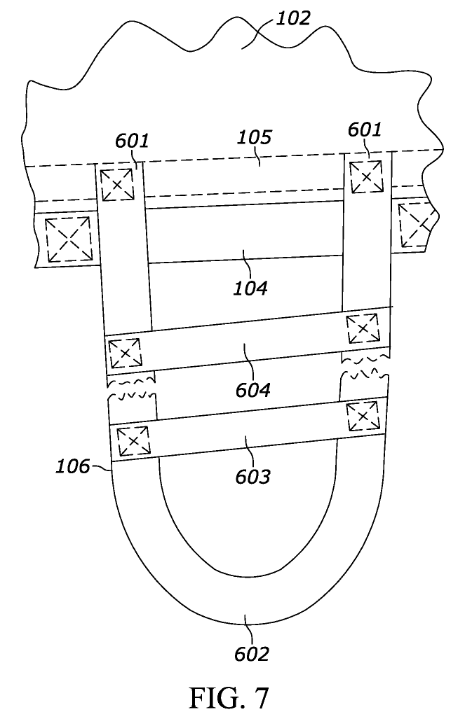

Referring to FIGS. 1, 2, and 7, the patient mobility apparatus 100 can further include at least two pairs of opposing first handles 106. In this illustrative example, there are three such pairs and the handles are comprised of one-inch-wide polypropylene webbing. These first handles 106 are each attached proximal to the exterior opposing edges of the inflatable envelope. As perhaps best illustrated in FIG. 7 (which presents a bottom view of the opposing surface 102), these first handles 106 are attached to the outer surface of the opposing surface 102 of the inflatable envelope but not to the patient-facing surface 101. (If desired, these teachings will also accommodate attaching the first handles 106 to both the opposing surface 102 and the patient-facing surface 101.) In particular, in this illustrative example, the ends 601 of the first handles 106 are attached via stitching to the aforementioned second flexible reinforcement member 105. (The ends 601 of these first handles 106 can also be attached via the same stitching to corresponding lateral support beams which are described further below.) (With reference to the illustrative example shown in FIGS. 1, 2, and 7, the two ends of the first handle 106 are shown spaced apart from one another. These teachings will also accommodate, if desired, disposing those two ends adjacent to one another without any distance there between.)

In this illustrative example, each of the first handles 106 includes an outwardly- oriented primary handle portion 602 and two additional inwardly located secondary handle portions 603 and 604. So configured, and particularly in view of the extended length of the primary handle portion 602, these first handles 106 are accordingly configured as patient lift apparatus connections. In particular, any of these handle portions (but especially the primary handle portion 602) are physically well suited to connect to the hooks on the support arms of a patient lift apparatus. That said, these first handles 106 and also the secondary handle portions 603 and 604 are also physically suitable to serve as human hand connections and hence offer yet further patient movement modality options.

By one approach, the cross pieces that comprise the secondary handle portions can be color-coded. For example, the cross pieces that are closest to the inflatable envelope can be one color (such as yellow) while the cross pieces that are furthest from the inflatable envelope can be a different color (such as red). Such color coding can help to assure coordinated and uniform usage of those secondary handle portions. In lieu of the foregoing, or in combination therewith, alphanumeric characters (such as "A, B, C" or "1, 2, 3") or any of a variety of graphic symbols could be utilized to serve the same purpose.

By one approach, and as illustrated in FIGS. 1 and 2, a third type of handle can be provided, referred to here as extended handles 107. These extended handles 107 are physically configured to serve only as human hand connections and not as patient lift apparatus connections.

These extended handles are attached in the same manner as the above- described first handles 106, and accordingly are attached to the opposing surface 102 of the inflatable envelope but not to the patient-facing surface 101 thereof. These extended handles 107 are shorter in length than the first handles 106, but are longer than the hand holds that are shown in FIG. 3. In this illustrative example, pairs of these extended handles 107 are disposed equidistant between longitudinal pairs of the first handles 106. If desired, these extended handles 107 can be comprised of the same material as the first handles 106 and may be similarly colored or differently colored as desired.

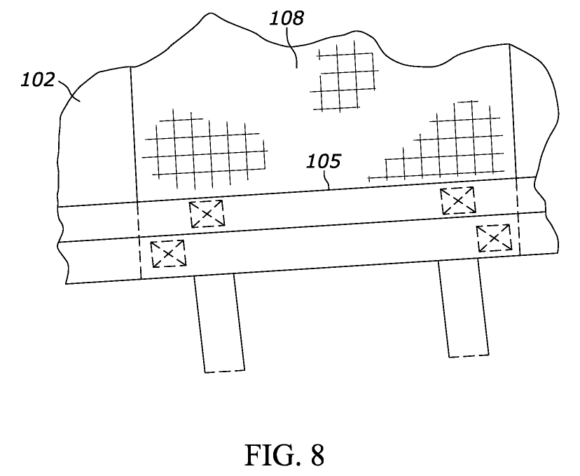

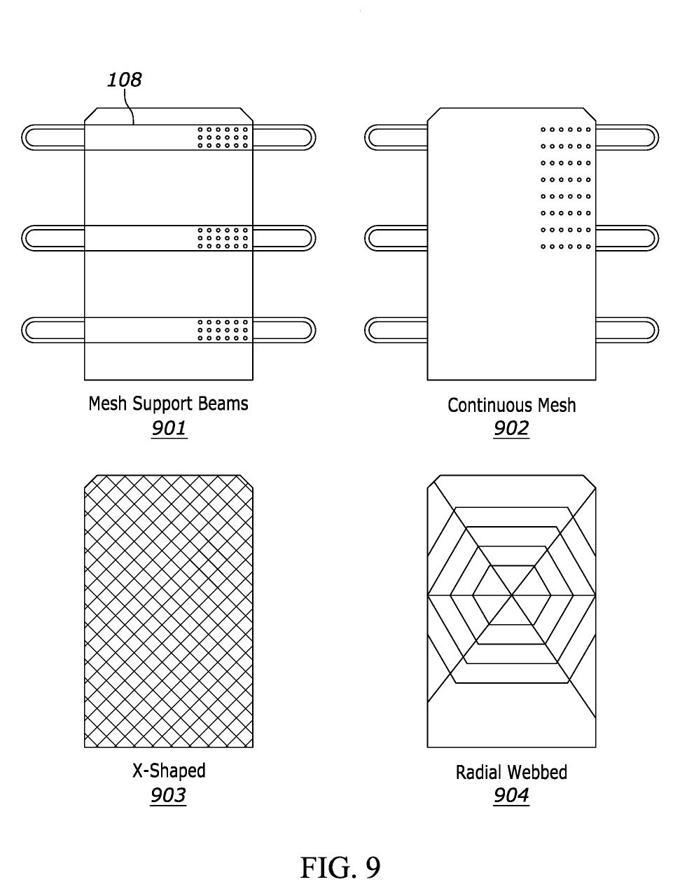

Referring in particular to FIGS. 1, 2, and 8 (wherein FIG. 8 provides a top plan view with the patient-facing surface 102 removed for the sake of illustrative clarity), by one approach a plurality of lateral support beams 108 can be provided. Each lateral support beam can comprise, for example, a mesh fabric such as a polyester mesh material. (FIG. 9 provides another illustrative example in these regards at reference numeral 901, with only a portion of the mesh being shown.) That said, these teachings will accommodate use of a variety of materials including woven and/or non-woven fabrics. Examples of other materials that can be used include, without intending to suggest any limitations in these regards, polypropylene, nylon (polyaramid), and cotton. Generally speaking, any of a wide variety of materials can be used that have a sufficient support strength such as a breaking force as determined by testing according to the American Society for Testing and Materials standard ASTM D5034-21 by way of the grab test carried out on a constant rate-of-extension tensile testing machine with a 25mm by 50mm top/front jaw face and a 50mm by 50mm bottom/back jaw face greater than, for example, 100 Newtons (though greater than 400 Newtons or even 900 Newtons may be more preferred). Sling material suitability can also be assessed through testing in accordance with the test method for durability for a non-rigid body-support unit as described in ISO 10535:2021 and then by subjecting the structure to a static load test of 1.5 times the maximum rated load for 24 hours. By one approach, a sufficient maximum rated load can be 400lbs, with 600lbs likely being more beneficial for many application settings and 1000bs being suitable for at least most application settings. A higher maximum rated load would be more preferable for bariatric patients while a lower maximum rated load may be sufficient for average-sized patients.

Each lateral support beam 108 can be attached with its opposing ends to the aforementioned first handles 106. In particular, each lateral support beam 108 can attach between one lateral pair of the opposing first handles 106 to thereby provide lateral support for that pair of opposing first handles 106.

In this illustrative example these lateral support beams 108 are disposed in the interior of the inflatable envelope. If desired, in lieu of the foregoing or in combination therewith, one of more of these support beams 108 may be positioned on the outer side of the opposing surface. Alternately, the support beams may be joined together each other with the same support material to form a contiguous support layer. For example, the polyester mesh material could come to form a contiguous cargo net-like internal structure (with an illustrative example shown at reference numeral 902 in FIG. 9 where only a portion of the mesh is shown) instead of three separate support beams. Without intending to suggest any limitations in these regards, other meshed shapes can include a cross lattice support (with the example at reference numeral 903 in FIG. 9 presenting an x-shaped example), a radial webbed shaped approach (such as a radial spider web configuration as shown in FIG. 9 at reference numeral 904), a neuron-like nexi, and so forth.

If desired, these teachings will support providing the patient mobility apparatus as a reprocessable offering such that the apparatus could be safely reused one or more times. Such reprocessing can include, for example, a cleaning (by, for example, an inhouse laundering facility and/or by a third party reprocessing service), an inspection, and/or sterilization. The inspection itself may include human and/or machine-assisted visual inspection and/or strength or other validation testing to confirm the integrity and function of the individual components and their corresponding assembly.

These teachings will also accommodate having instructional content disposed on one or more of the surfaces associated with the various components of this apparatus. That content may include, for example, one or more pictures, textual instructions, a QR code that directs the user to an on-line resource that offers information regarding use, storage, care, and/or reprocessing of the apparatus, and so forth. In lieu of the foregoing, or in combination therewith, packaging for the apparatus may include such instructional content and/or may include content (such as images, text, color coding and/or number coding) to help, for example, users to distinguish sizes and differences between this and similar patient transfer and lift devices.

Further aspects of the invention are provided by the subject matter of the following clauses (where it will be understood that any of these clauses can be combined with any one of more of the other clauses as appropriate).

Clause 1. A patient mobility apparatus for use with or without a patient lift apparatus, the patient mobility apparatus comprising: an inflatable envelope having a patient-facing surface and an opposing surface; at least two pairs of opposing first handles attached proximal to exterior opposite edges of the inflatable envelope, wherein the first handles are attached to the opposing surface but not the patient- facing surface.

Clause 2. The patient mobility apparatus of clause 1 wherein the at least two pairs of opposing first handles are each configured as patient lift apparatus connections.

Clause 3. The patient mobility apparatus of clause 2 further comprising: a plurality of lateral support beams that each attaches between one pair of the opposing first handles to thereby provide lateral support for the at least two pairs of opposing first handles.

Clause 4. The patient mobility apparatus of clause 3 wherein the lateral support beams each comprises a mesh fabric.

Clause 5. The patient mobility apparatus of clause 3 wherein the lateral support beams are disposed interior to the inflatable envelope.

Clause 6. The patient mobility apparatus of clause 3 further comprising: at least two pairs of opposing second handles attached proximal to exterior opposite edges of the inflatable envelope, wherein the opposing second handles are attached to the opposing surface but not the patient-facing surface and wherein the at least two pairs of opposing second handles are each configured only as human hand connections.

Clause 7. The patient mobility apparatus of clause 6 wherein the at least two pairs of opposing second handles do not have a lateral support beam attached thereto.

Clause 8. The patient mobility apparatus of clause 7 wherein the at least two pairs of opposing first handles are each configured as both patient lift apparatus connections and human hand connections.

Clause 9. The patient mobility apparatus of clause 1 further comprising: a flexible reinforcement member that is attached to the opposing surface along and proximal to exterior edges of the inflatable envelope but not to the patient-facing surface.

Clause 10. The patient mobility apparatus of clause 9 wherein the flexible reinforcement member and the at least two pairs of opposing first handles are not attached to one another.

Clause 11. A method for forming a patient mobility apparatus for use with or without a patient lift apparatus, the method comprising: providing an inflatable envelope having a patient-facing surface and an opposing surface; attaching at least two pairs of opposing first handles to the inflatable envelope proximal to exterior opposite edges of the inflatable envelope, wherein the first handles are attached to the opposing surface but not the patient-facing surface.

Clause 12. The method of clause 11 wherein the at least two pairs of opposing first handles are each configured as patient lift apparatus connections.

Clause 13. The method of clause 12 further comprising: attaching a plurality of lateral support beams to the patient mobility apparatus such that there is one of the lateral support beams that attaches between each pair of the opposing first handles to thereby provide lateral support for the at least two pairs of opposing first handles.

Clause 14. The method of clause 13 wherein the lateral support beams each comprise a mesh fabric.

Clause 15. The method of clause 13 wherein the lateral support beams are disposed interior to the inflatable envelope.

Clause 16. The method of clause 13 further comprising: attaching at least two pairs of opposing second handles on exterior opposite edges of the inflatable envelope, wherein the opposing second handles are attached to the opposing surface but not the patient-facing surface and wherein the at least two pairs of opposing second handles are each configured only as human hand connections.

Clause 17. The method of clause 16 wherein the at least two pairs of opposing second handles do not have a lateral support beam attached thereto.

Clause 18. The method of clause 17 wherein the at least two pairs of opposing first handles are each configured as both patient lift apparatus connections and human hand connections.

Clause 19. The method of clause 11 further comprising: attaching a flexible reinforcement member to both the patient-facing surface and the opposing surface along exterior edges of the inflatable envelope.

Clause 20. The method of clause 19 wherein the flexible reinforcement member and the at least two pairs of opposing first handles are not attached to one another.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A patient mobility apparatus for use with or without a patient lift apparatus, the patient mobility apparatus comprising:an inflatable envelope having a patient-facing surface and an opposing surface;at least two pairs of opposing first handles attached proximal to exterior opposite edges of the inflatable envelope, wherein the first handles are attached to the opposing surface but not the patient-facing surface.

2. The patient mobility apparatus of claim 1 wherein the at least two pairs of opposing first handles are each configured as patient lift apparatus connections.

3. The patient mobility apparatus of claim 2 further comprising:a plurality of lateral support beams that each attaches between one pair of the opposing first handles to thereby provide lateral support for the at least two pairs of opposing first handles.

4. The patient mobility apparatus of claim 3 wherein the lateral support beams each comprises a mesh fabric.

5. The patient mobility apparatus of claim 3 wherein the lateral support beams are disposed interior to the inflatable envelope.

6. The patient mobility apparatus of claim 3 further comprising:at least two pairs of opposing second handles attached at and proximal to exterior opposite edges of the inflatable envelope, wherein the opposing second handles are attached to the opposing surface but not the patient-facing surface and wherein the at least two pairs of opposing second handles are each configured only as human hand connections.

7. The patient mobility apparatus of claim 6 wherein the at least two pairs of opposing second handles do not have a lateral support beam attached thereto.

8. The patient mobility apparatus of claim 7 wherein the at least two pairs of opposing first handles are each configured as both patient lift apparatus connections and human hand connections.

9. The patient mobility apparatus of claim 1 further comprising:a flexible reinforcement member that is attached to the opposing surface proximal to and along exterior edges of the inflatable envelope but not to the patient-facing surface.

10. The patient mobility apparatus of claim 9 wherein the flexible reinforcement member and the at least two pairs of opposing first handles are not attached to one another.

11. A method for forming a patient mobility apparatus for use with or without a patient lift apparatus, the method comprising:providing an inflatable envelope having a patient-facing surface and an opposing surface;attaching at least two pairs of opposing first handles to the inflatable envelope proximal to exterior opposite edges of the inflatable envelope, wherein the first handles are attached to the opposing surface but not the patient-facing surface.

12. The method of claim 11 wherein the at least two pairs of opposing first handles are each configured as patient lift apparatus connections.

13. The method of claim 12 further comprising:attaching a plurality of lateral support beams to the patient mobility apparatus such that there is one of the lateral support beams that attaches between each pair of the
opposing first handles to thereby provide lateral support for the at least two pairs of opposing first handles.

14. The method of claim 13 wherein the lateral support beams each comprise a mesh fabric.

15. The method of claim 13 wherein the lateral support beams are disposed interior to the inflatable envelope.

16. The method of claim 13 further comprising:attaching at least two pairs of opposing second handles proximal to exterior opposite edges of the inflatable envelope, wherein the opposing second handles are attached to the opposing surface but not the patient-facing surface and wherein the at least two pairs of opposing second handles are each configured only as human hand connections.

17. The method of claim 16 wherein the at least two pairs of opposing second handles do not have a lateral support beam attached thereto.

18. The method of claim 17 wherein the at least two pairs of opposing first handles are each configured as both patient lift apparatus connections and human hand connections.

19. The method of claim 11 further comprising:attaching a flexible reinforcement member to both the patient-facing surface and the opposing surface along exterior edges of the inflatable envelope.

20. The method of claim 19 wherein the flexible reinforcement member and the at least two pairs of opposing first handles are not attached to one another.
